(19) United States
(12) Patent Application Publication
(10) Pub. No.: US 2025/0137788 A1
(43) Pub. Date: May 1, 2025

(54) Indoor Waypoint System

(71) Applicant: GOOGLE LLC, Mountain View, CA (US)

(72) Inventor: Dongeek Shin, Mountain View, CA (US)

(21) Appl. No.: 18/575,091

(22) PCT Filed: Mar. 28, 2023
(86) PCT No.: PCT/US23/16488

§ 371 Date: Dec. 28, 2023

(51) Int. Cl. G01C 21/20; H04W 4/02; H04W 4/33; H04W 4/80

(52) U.S. Cl. CPC G01C 21/206; H04W 4/025; H04W 4/33; H04W 4/80

(57) ABSTRACT

To determine the location of a user, a computing device determines a current location of the user and a destination location. The computing device then determines a plurality of paths for traveling from the current location to the destination location. As the user travels to the destination location, the computing device estimates a plurality of waypoints traversed by the user. The computing device compares the estimated plurality of waypoints to each of the plurality of paths to identify a path of the plurality of paths in which the user travels to the destination location. Then the computing device adjusts the estimated plurality of waypoints according to the identified path to determine precise waypoints for the user.

### FIELD OF THE DISCLOSURE

This disclosure relates to indoor localization, and more specifically, to determining accurate locations of a user without installing beacons or additional hardware.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Today, digital maps of geographic areas are commonly displayed on computing devices, such as computers, tablets, and mobile phones via mapping applications, web browsers, etc. Many mapping applications provide the user with the ability to select the type of map information or features for viewing as well as to adjust the display of the digital map.

The mapping applications typically use a global positioning system (GPS) sensor to locate the user and provide map information or navigation directions based on the user's current location. However, GPS is known to be inaccurate indoors. As a result, it is difficult to locate a user indoors and provide map information and navigation directions at indoor locations. Moreover, even with the limited indoor location solutions that exist today, current indoor mapping solutions require extensive hardware installation which is costly, time consuming, and difficult to scale

### SUMMARY

To determine an accurate location of a user (e.g., an indoor location) without having to install additional hardware, an indoor waypoint system uses existing sensors on client devices (e.g., global positioning system (GPS)) sensors and existing communication interfaces (e.g., very short-range communication links, such as Near Field Communication (NFC), high frequency Radio-Frequency Identification (HF RFID), etc.).

A user's client device communicates with an electronic tag (e.g., a payment device, a “You are here” panel in a shopping mall, etc.) at a known location (e.g., a retail store) via a very short-range communication link. The user's client device can then infer that the user is at the known location by being within communication range of the electronic tag transmitting a very short-range communication. The known location may be the user's current location or starting location.

Additionally, the user may enter user input to a mapping application on the client device to provide the user's destination. In other implementations, the user's destination may also be determined when the user arrives at the destination and is within communication range of an electronic tag at the destination transmitting a very short-range communication. In this manner, the indoor waypoint system can determine the user's starting location and destination location in an accurate manner without noise or in a way that reduces noise compared to using positioning sensors, such as GPS.

Then as the user travels from the starting location to the destination location, the client device estimates noisy or inaccurate waypoints/locations for the user, for example via the GPS sensor. To improve the accuracy of these location/waypoint estimates, the indoor waypoint system determines a set of possible paths from the starting location to the destination location. For example, the indoor waypoint system may obtain a floor plan or a map of a geographic area that includes the starting location and the destination location. Then the indoor waypoint system may identify each unobstructed path from the starting location to the destination location according to the floor plan or map, for example using a pathfinding algorithm.

For each unobstructed path, the indoor waypoint system may compare a set of waypoints on the unobstructed path to the estimated waypoints for the user. The indoor waypoint system may then identify the path having waypoints which are closest to the estimated waypoints as the path taken by the user to reach the destination location.

In some implementations, the indoor waypoint system may identify the path in real-time or near real-time as the user is traveling to the destination, such as when the user enters the destination location before traveling to the destination location. Then once the path is identified, the indoor waypoint system may adjust each subsequent estimated waypoint to a nearest waypoint on the identified path to determine a precise waypoint for the user. The client device may present an indication of the precise waypoint for example on a map display as the user travels to the destination. The client device may continuously or periodically update the position of the precise waypoint on the map display as the user gets closer to the destination.

In other implementations, the indoor waypoint system may identify the path after the user arrives at the destination, such as when the destination is not determined until the user arrives at the destination and communicates with an electronic tag at the destination.

The indoor waypoint system may determine correction values based on differences between each estimated waypoint and a nearest waypoint on the identified path. Then when the user travels to a location corresponding to the estimated waypoint at another point in time (e.g., after traveling to the destination, another day, etc.), the indoor waypoint system applies the correction value for the estimated waypoint to determine a precise waypoint for the user. The client device may then present an indication of the precise waypoint on the map display instead of the estimated waypoint.

In this manner, the indoor waypoint system can identify and present the user's location in a more accurate manner, for example on a map display without having to install additional hardware. The indoor waypoint system can correct inaccuracies with positioning sensors, particularly indoors, by identifying a path that the user is most likely taking/took to the destination and determining that the user is/was on the path. As a result, a noisy estimated waypoint is transformed into a precise waypoint using the identified path.

An example embodiment of these techniques is a method for determining a location of a user. The method includes determining a current location of a user and a destination location, and determining a plurality of paths for traveling from the current location to the destination location. As the user travels to the destination location, the method includes estimating a plurality of waypoints traversed by the user, and comparing the estimated plurality of waypoints to each of the plurality of paths to identify a path of the plurality of paths in which the user travels to the destination location. Additionally, the method includes adjusting the estimated plurality of waypoints according to the identified path to determine precise waypoints for the user.

Another example embodiment of these techniques is a computing device for determining a location of a user. The computing device includes one or more processors and a computer-readable memory, which may be non-transitory, coupled to the one or more processors and storing instructions thereon. When executed by the one or more processors, the instructions cause the computing device to determine a current location of a user and a destination location, and determine a plurality of paths for traveling from the current location to the destination location. As the user travels to the destination location, the instructions cause the computing device to estimate a plurality of waypoints traversed by the user, and compare the estimated plurality of waypoints to each of the plurality of paths to identify a path of the plurality of paths in which the user travels to the destination location. Additionally, the instructions cause the computing device to adjust the estimated plurality of waypoints according to the identified path to determine precise waypoints for the user.

Yet another example embodiment of these techniques is a computer-readable memory, which may be non-transitory, coupled to one or more processors and storing instructions thereon. The instructions cause the one or more processors to determine a current location of a user and a destination location, and determine a plurality of paths for traveling from the current location to the destination location. As the user travels to the destination location, the instructions cause the one or more processors to estimate a plurality of waypoints traversed by the user, and compare the estimated plurality of waypoints to each of the plurality of paths to identify a path of the plurality of paths in which the user travels to the destination location. Additionally, the instructions cause the one or more processors to adjust the estimated plurality of waypoints according to the identified path to determine precise waypoints for the user.

### BRIEF DESCRIPTION OF THE DRAWINGS

FIG. 1 is a block diagram of an example indoor waypoint system that implements the techniques of this disclosure;

FIG. 2 is an example display of two alternate paths which a user can traverse to navigate from their current location to a destination location;

FIG. 3A is an example display of noisy waypoints estimated for the user, for example via a positioning sensor at the user's client device, as the user travels to the destination location;

FIG. 3B is an example display of precise waypoints identified for the user based on a most likely path taken by the user to travel to the destination location;

FIG. 4 is an example indoor map display for presenting the user's precise current location as the user travels to a destination location, which may be presented on a client device; and

FIG. 5 is a flow diagram of an example method for determining a location of a user, which can be implemented in a client device.

### DETAILED DESCRIPTION OF THE DRAWINGS

### Overview

Generally speaking, the techniques of this disclosure allow a client device to precisely determine its location, which may be an indoor location, by estimating the user's location as the user travels to a destination, identifying a most likely path taken by the user to travel to the destination, and adjusting the location estimates in accordance with the identified path to determine precise locations/waypoints for the user. The location estimates may be adjusted retroactively, for example, upon identifying the most likely path. In some scenarios, the location estimates may be adjusted in real-time or at least near real-time to determine precise locations/waypoints for the user as the user is traveling to the destination. For example, once the most likely path is identified, the client device may automatically adjust subsequent location estimates for the user according to the identified path. Then the client device may present the adjusted subsequent location estimates as precise locations/waypoints on an indoor map display.

In some implementations, the techniques of this disclosure can be implemented solely on the client device without receiving data from a network server. In other implementations, the techniques of this disclosure include a network server that provides map data to the client device, such as a floor plan for the area surrounding the user or the building that the user enters.

The network server may also provide navigation data to the client device indicating possible routes or paths a user may take within a particular area, such as a building. The navigation data may include unobstructed route segments within the particular area. For example, to travel from a starting location to a destination location within a building, there may be a finite number of paths that the user can take by traversing a set of unobstructed route segments. The network server may provide the paths or may provide the unobstructed route segments and the client device may determine the paths that the user can take from a starting location to a destination location using the unobstructed route segments. The client device can then use the map and/or navigation data along with the estimated locations for the user to identify a most likely path of the user and adjust the estimated locations according to the identified path.

A waypoint is interchangeably referred to throughout this disclosure as “a location.” A waypoint, as used herein, is a user's location as the user travels to a destination.

### Example Hardware and Software Components

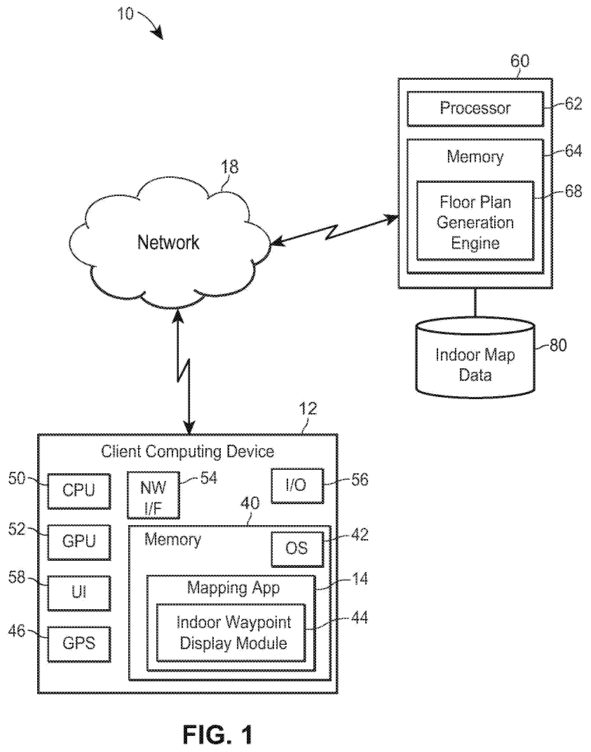

Referring to FIG. 1, an example communication system 10 in which an indoor waypoint system can be implemented includes a client computing device 12 (also referred to herein as a “client device”) configured to execute a geographic application 14, which also can be referred to as “mapping application 14.” Depending on the implementation, the mapping application 14 can display an interactive digital map, request and receive routing data to provide driving, walking, or other navigation directions, provide tours of geographic areas, provide various geolocated content, etc. The client device 12 may be operated by a user displaying a digital map while navigating to various locations.

In addition to the client device 12, the communication system 10 includes a server device 60 configured to provide map and/or navigation data to the client device 12. For example, the server device 60 may provide a floor plan for the area surrounding the user or the building that the user enters. The server device 60 may also provide the locations of points of interest (POIs) within the floor plan, such as restaurants, department stores, movie theatres, etc. Additionally, the server device 60 may provide routes or paths from various starting locations to various destination locations. In other implementations, the server device 60 may provide a set of unobstructed route segments within the floor plan. The client device 12 may then construct the paths from a starting location to a destination location via the unobstructed route segments, using a pathfinding algorithm for example.

The server device 60 can be communicatively coupled to a database 80 that stores, in an example implementation, indoor map data such as floor paths, unobstructed route segments, locations of POIs, etc.

More generally, the server device 60 can communicate with one or several databases that store any type of suitable geospatial information. For example, the communication system 10 can include a navigation data server that provides driving, walking, biking, or public transit directions, for example for presentation via the mapping application 14. Further, the communication system 10 can include a map data server that provides map data. The devices operating in the communication system 10 can be interconnected via a communication network 18.

The map data server and navigation server may be coupled to a map database which includes schematic and satellite data storing street and road information, topographic data, satellite imagery, etc. In general, the server device 60 can receive information related to geographic locations from any number of suitable databases, servers, web services, etc.

The map database can store data in a raster format, a vector format, in any other suitable format or any combination thereof. In some implementations, the data is organized into map tiles at multiple zoom levels to facilitate serving map data to client devices.

In some implementations, the server device 60 receives map and/or navigation data from the map data server and/or the navigation server. In other implementations, the server device 60 obtains the map and/or navigation data from the indoor map database 80.

The client device 12 may be a portable device such as smart phone or a tablet computer, for example. The client device 12 may also be a laptop computer, a desktop computer, a personal digital assistant (PDA), a wearable device such as a smart watch or smart glasses, a virtual reality (VR) headset, etc. The client device 12 also can communicate with various content providers, servers, etc. via a wired or wireless communication network 18 such as a fourth- or third-generation cellular network (4G or 3G, respectively). The client device 12 may include a memory 40, one or more processors (CPUs) 50, a graphics processing unit (GPU) 52, a network interface unit 54, an I/O module 56, a user interface (UI) 58 for displaying map data and directions, and a global positioning system (GPS) 46 or other suitable positioning sensor.

The network interface unit 54 can include a wireless transceiver for transmitting/receiving radio signals via a very short-range communication link, such as Near Field Communication (NFC), high frequency Radio-Frequency Identification (HF RFID), etc. A very short-range communication link may be a communication link between devices where data is transmitted within a threshold distance (e.g., one inch, three inches, six inches, a foot, etc.). The wireless transceiver may also be configured to transmit/receive signals via short-range communication links, such as Bluetooth, RFID, Wi-Fi, etc., and long-range communication links, such as the Internet.

The memory 40 can be a non-transitory memory and can include one or several suitable memory modules, such as random access memory (RAM), read-only memory (ROM), flash memory, other types of persistent memory, etc. The I/O module 56 may be a touch screen, for example. In various implementations, the client device 12 can include fewer components than illustrated in FIG. 1 or conversely, additional components.

The memory 40 stores an operating system (OS) 42, which can be any type of suitable mobile or general-purpose operating system. The memory 40 also stores a mapping application 14 which is configured to generate interactive digital maps and/or perform other geographic functions, as indicated above. The mapping application 14 can receive map data in a raster (e.g., bitmap) or non-raster (e.g., vector graphics) format from the server device 60 and present the map data via the indoor waypoint display module 44. In some cases, the map data can be organized into layers, such as a basic layer depicting roads, streets, natural formations, etc., a traffic layer depicting current traffic conditions, a weather layer depicting current weather conditions, a navigation layer depicting a path to reach a destination, etc. The mapping application 14 also can display driving, walking, or transit directions, and in general provide functions related to geography, geolocation, navigation, etc. via the indoor waypoint display module 44. Additionally, the mapping application 14 can display POIs. The mapping application 14 can also display indications of the location of a user, for example as the user travels from one location to the next within a particular area, such as a building.

The indoor waypoint display module 44 in the mapping application 14 is configured to determine a user's starting location and destination location. For example, the indoor waypoint display module 44 may determine the user's starting location by communicating with an electronic tag (e.g., a payment device, a “You are here” panel in a shopping mall, etc.) at a known location (e.g., a retail store) via a very short-range communication link. Due to the proximity to the electronic tag by being within very short-range communication range of the client device 12, the indoor waypoint display module 44 may determine that the user's starting location is the location of the electronic tag. In other implementations, the user may enter user input via user controls at the indoor waypoint display module 44 to provide the user's starting location.

The indoor waypoint display module 44 may determine the user's destination location (e.g., Bill's Hardware) by receiving user input via user controls at the indoor waypoint display module 44 indicating the user's destination location. In this manner, the indoor waypoint display module 44 determines the user's destination location before the user arrives at the destination location. In other implementations, the indoor waypoint display module 44 determines the user's destination location when the user arrives at the destination location by communicating with an electronic tag at a known location at the destination via a very short-range communication link.

The indoor waypoint display module 44 is also configured to determine precise locations/waypoints for the user as the user travels from the starting location to the destination location. More specifically, the indoor waypoint display module 44 is configured to estimate the user's locations/waypoints via the GPS sensor 46, and identify a most likely path that the user takes to travel to the destination based on the location estimates and a set of candidate paths for traveling to the destination. Then the indoor waypoint display module 44 is configured to adjust the location estimates and/or subsequent location estimates to the nearest waypoints on the identified path.

It is noted that although FIG. 1 illustrates the mapping application 14 as a standalone application, the functionality of the mapping application 14 also can be provided in the form of an online service accessible via a web browser executing on the client device 12, as a plug-in or extension for another software application executing on the client device 12, etc. The mapping application 14 generally can be provided in different versions for different respective operating systems. For example, the maker of the client device 12 can provide a Software Development Kit (SDK) including the mapping application 14 for the Android™ platform, another SDK for the iOS™ platform, etc.

In some implementations, the server device 60 includes one or more processors 62 and a memory 64. The memory 64 may be tangible, non-transitory memory and may include any types of suitable memory modules, including random access memory (RAM), read-only memory (ROM), flash memory, other types of persistent memory, etc. The memory 64 stores instructions executable on the processors 62 that make up a floor plan generation engine 68, which can generate a floor plan for the area surrounding the user, such as a building where the user is located. The floor plan generation engine 68 can also generate a set of unobstructed route segments within the floor plan and/or a set of paths from a starting location to a destination location. The floor plan generation engine 68 may provide the floor plan, the set of unobstructed route segments, and/or the set of paths to the client device 12. The floor plan generation engine 68 may also obtain additional map and/or navigation data, for example, from the map data server and/or navigation server. The floor plan generation engine 68 may then provide the additional map and/or navigation data to the client device 12.

The floor plan generation engine 68 and the indoor waypoint display module 44 can operate as components of an indoor waypoint system. Alternatively, the indoor waypoint system can include only server-side components and simply provide the indoor waypoint display module 44 with instructions to display the user's location within a map display. In other words, indoor waypoint techniques in these embodiments can be implemented transparently to the indoor waypoint display module 44. As another alternative, the entire functionality of the floor plan generation engine 68 can be implemented in the indoor waypoint display module 44. In other words, the entire functionality of the indoor waypoint system can be performed locally on the client device 12. In this manner, the user does not have to share their location with a server device 60 and can preserve their privacy.

For simplicity, FIG. 1 illustrates the server device 60 as only one instance of a server device. However, the server device 60 according to some implementations includes a group of one or more server devices, each equipped with one or more processors and capable of operating independently of the other server devices. Server devices operating in such a group can process requests from the client device 12 individually (e.g., based on availability), in a distributed manner where one operation associated with processing a request is performed on one server device while another operation associated with processing the same request is performed on another server device, or according to any other suitable technique. For the purposes of this discussion, the term “server device” may refer to an individual server device or to a group of two or more server devices.

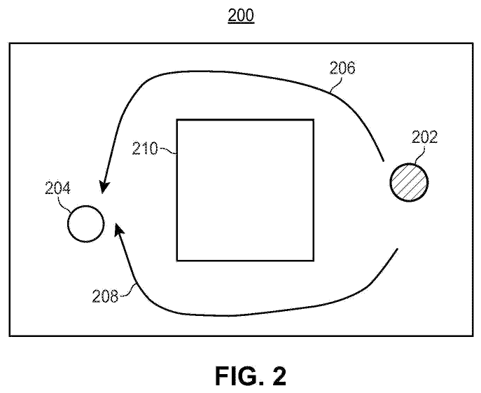

FIG. 2 illustrates an example display 200 of a user's current or starting location 202 and a destination location 204. The user may be within an indoor area such as a building, and the display 200 may be a floor plan of the indoor area. A square 210 is located in the center of the floor plan which may represent walls which obstruct the user's direct path from the starting location 202 to the destination location 204. Instead, the user can travel along one of two candidate paths 206, 208 to arrive at the destination location 204.

To identify these candidate paths 206, 208, the indoor waypoint display module 44 may obtain the floor plan 210 of the indoor area from the server device 60. The indoor waypoint display module 44 may also obtain a set of unobstructed route segments within the floor plan 210 from the server device 60 or may identify the set of unobstructed route segments by analyzing the floor plan 210 and identifying segments which are not obstructed by a wall, door, or other obstruction. Then the indoor waypoint display module 44 may identify a path from the starting location 202 to the destination location 204 using a set of connecting unobstructed route segments from the starting location 202 to the destination location 204.

The indoor waypoint display module 44 may repeat this process of identifying different sets of connecting unobstructed route segments from the starting location 202 to the destination location 204 to identify candidate paths from the starting location to the destination location 204. In the example illustrated in FIG. 2, the indoor waypoint display module 44 identifies two candidate paths 206, 208. In other implementations, the indoor waypoint display module 44 may provide indications of the starting location 202 and the destination location 204 to the server device 60. The server device 60 may then identify each of the candidate paths from the starting location 202 and the destination location 204, for example using a pathfinding algorithm, and may provide the candidate paths to the indoor waypoint display module 44.

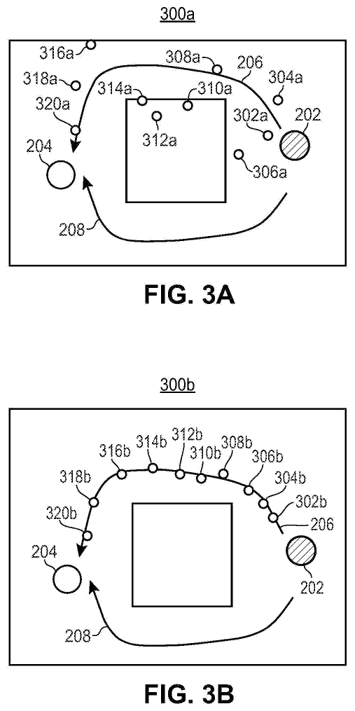

In addition to identifying the candidate paths 206, 208, the indoor waypoint display module 44 estimates the user's locations/waypoints via the GPS sensor 46 as the user travels from the starting location 202 to the destination location 204. FIG. 3A illustrates an example display 300a of noisy waypoints 302a-320a estimated for the user, for example via the GPS sensor 46, as the user travels to the destination location 204. In the example display 300a, the location estimates 302a-320a include locations 310a-314a which are obstructed by a wall and could not be reached by the user. As mentioned above, these location estimates 302a-320a are noisy and inaccurate for example, due to inaccuracies with GPS sensors 46 indoors.

To correct these inaccuracies and identify precise waypoints for the user, the indoor waypoint display module 44 compares waypoints of each candidate path 206, 208 to the location estimates 302a-320a. The indoor waypoint display module 44 then identifies the path 206 of the candidate paths 206, 208 having waypoints which are closest to the location estimates 302a-320a as the most likely path taken by the user to reach the destination location 204. For example, for each candidate path 206, 208, the indoor waypoint display module 44 may determine the Euclidean distance between a location estimate 302a-320a and the nearest waypoint on the candidate path 206, 208 to the location estimate 302a-320a.

The indoor waypoint display module 44 may repeat this process for each location estimate 302-320a and may aggregate or average the Euclidean distances for each of the location estimates 302a-320a to determine an aggregate or average Euclidean distance for the candidate path 206, 208. Then the indoor waypoint display module 44 may identify the candidate path with the smallest aggregate or average Euclidean distance as the most likely path.

In other implementations, the indoor waypoint display module 44 may determine the distance in a particular direction (e.g., the east-west direction (also referred to herein as the “x-direction”), the north-south direction (also referred to herein as the “y-direction”), etc.) between a location estimate 302a-320a and the nearest waypoint in that particular direction. For example, for each waypoint on a candidate path 206, 208, the indoor waypoint display module 44 may generate a line perpendicular to the line of the candidate path 206, 208 at the waypoint. If the candidate path 206, 208 is curved, the indoor waypoint display module 44 may generate a line perpendicular to a tangent line that intersects with the curve at the waypoint. Then the indoor waypoint display module 44 may identify a location estimate 302a-320a on the perpendicular line and determine the distance in the direction of the perpendicular line from the location estimate 302a-320a to the waypoint.

The indoor waypoint display module 44 may repeat this process for each location estimate 302-320a and may aggregate or average the distances in the particular direction for each of the location estimates 302a-320a to determine an aggregate or average distance in the particular direction for the candidate path 206, 208. Then the indoor waypoint display module 44 may identify the candidate path with the smallest aggregate or average distance in the particular direction as the most likely path.

In some implementations, the indoor waypoint display module 44 may only identify a candidate path 206, 208 as the most likely path when the aggregate or average distance is below a threshold. If none of the candidate paths 206, 208 have an aggregate or average distance which is below the threshold, the indoor waypoint display module 44 may continue obtaining location estimates 302a-320a for the user until one of the candidate paths 206, 208 has an aggregate or average distance which is below the threshold. In other implementations, the indoor waypoint display module 44 may only identify a candidate path 206, 208 as the most likely path when a threshold number of location estimates 302a-320a have been obtained. For example, the indoor waypoint display module 44 may not identify a most likely path when only one or two location estimates have been obtained.

In some implementations, the indoor waypoint display module 44 may assign similarity scores or metrics to each of the candidate paths 206, 208 based on an amount of similarity between the candidate path 206, 208 and the location estimates 302a-320a. For example, the similarity score or metric may be inversely related to the aggregate or average distance. Then the indoor waypoint display module 44 may rank the candidate paths 206, 208 according to the similarity scores or metrics, and identify the candidate path 206, 208 ranked the highest/having the highest similarity score or metric as the most likely path.

In any event, the indoor waypoint display module 44 identifies the path 206 as the most likely path taken by the user to reach the destination location 204. The location estimates 302a-320a are closer to the waypoints on the candidate path 206 than the waypoints on the candidate path 208.

Accordingly, the indoor waypoint display module 44 adjusts the location estimates 302a-320a to the nearest waypoints on the identified path 206. The nearest waypoint to a location estimate 302a-320a may be determined as the waypoint having the shortest Euclidean distance to the location estimate 302a-320a, the shortest distance in a particular direction to the location estimate 302a-320a (e.g., the direction perpendicular to the direction of the path at the particular waypoint), or in any other suitable manner. FIG. 3B illustrates an example display 300b of the adjusted location estimates 302b-320b in accordance with the identified path 206. These adjusted location estimates 302b-320b are determined to be the precise waypoints for the user. Once the path 206 has been identified, the indoor waypoint display module 44 may obtain subsequent location estimates as the user travels to the destination 204 and adjust the subsequent location estimates in real-time to the nearest waypoints on the identified path 206. The identification of the path 206 as the most likely path may be based on a threshold number of location estimates 302a-320a not only being obtained, but also each having aggregate or average distances within a threshold distance from the path 206. The threshold number of location estimates having aggregate or average distances within a threshold distance from the path 206 may be at least 2, for example. Once this threshold has been met, the path 206 may be identified as the most likely path and subsequent location estimates may be automatically adjusted in real-time to the nearest waypoints on the identified path 206. In this manner, the subsequent location estimates may provide a precise waypoint of the user.

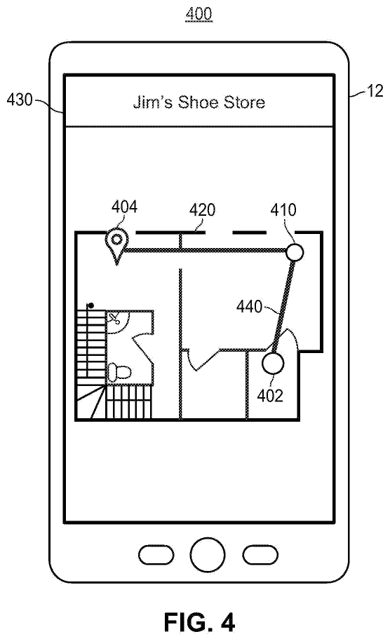

The indoor waypoint display module 44 may then present an indication of the precise waypoint of the user on an indoor map display as shown in FIG. 4. FIG. 4 illustrates an example indoor map display 400 presented on the client device 12. The indoor map display 400 may include a user control 430 such as a text box for entering the user's destination location 404 (e.g., “Jim's Shoe Store”). The indoor map display 400 may also include a floor plan 420 of the building or area where the user is located. Additionally, the indoor map display 400 includes an indication of the user's current location 402 within the floor plan 420. The indoor waypoint display module 44 may determine the user's current location 402 by receiving a very short-range communication signal from an electronic tag at a known location (e.g., a retail store, a “You are here” panel, etc.). The indoor map display 400 may also include an indication of the user's destination location 404, such as a pin or other icon. As the user travels from the current or starting location 402 to the destination location 404, the indoor waypoint display module 44 identifies the most likely path 440 of the user using the techniques described above. Then upon identifying the most likely path 440 of the user, the indoor waypoint display module 44 identifies precise waypoints for the user, and the indoor map display 400 presents an indication of the user's precise waypoint/location 410 as a waypoint on the identified path 440.

For example, the indoor waypoint display module 44 continuously or periodically estimates the user's location by obtaining updated GPS signals from the GPS sensor 46. Then for each location estimate, the indoor waypoint display module 44 adjusts the location estimate to a waypoint on the identified path and presents an indication of the waypoint on the identified path 400 as the user's precise waypoint/location 410. As the user continues traveling to the destination location 404, the indoor map display 400 continuously or periodically updates the precise waypoint/location 410 of the user.

In addition to adjusting location estimates for presenting the user's location on a map display, the indoor waypoint display module 44 stores each location estimate and its corresponding precise waypoint/location as a correction value in a database. Then when the indoor waypoint display module 44 later obtains a location estimate for the user matching one of the location estimates in the database, the indoor waypoint display module 44 automatically applies the correction value to the location estimate to determine the precise location for the user. The indoor waypoint display module 44 may obtain these location estimates when the user is not traveling to a destination location or the destination location is unknown. In this manner, the indoor waypoint display module 44 can determine the user's precise location for location estimates which have been previously analyzed without having to once again identify the path of the user. Beneficially, this allows for accurate position estimation without requiring a destination location to be explicitly provided in advance.

Also in some implementations, the indoor waypoint display module 44 may not determine the user's destination location until the user arrives at the destination location. For example, upon arriving at the destination location, the client device 12 may receive a very short-range communication signal from an electronic tag at a known location (e.g., a retail store). Then the indoor waypoint display module 44 may obtain a set of candidate paths from the starting location to the destination location, and identify the most likely path of the user by comparing location estimates obtained while the user was traveling to the destination location to each of the candidate paths. Upon identifying the most likely path of the user, the indoor waypoint display module 44 may adjust the location estimates to waypoints on the identified path and store the location estimates and corresponding precise waypoints/locations as correction values. Then as the user continues to travel in the same area, the indoor waypoint display module 44 may automatically apply the correction values to location estimates matching the stored location estimates to determine the user's precise location.

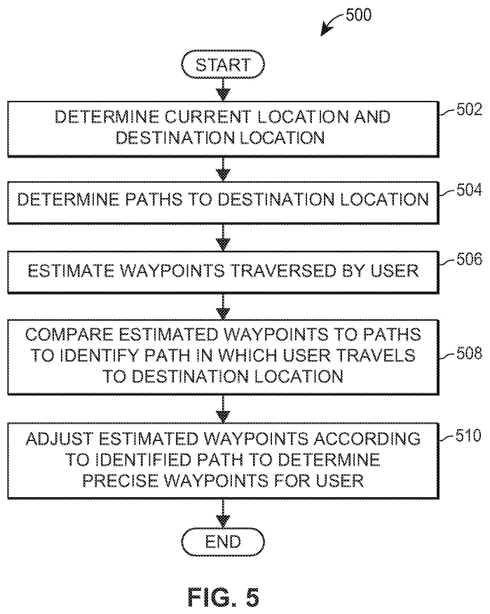

FIG. 5 illustrates a flow diagram of an example method 500 for determining a location of a user. The method 500 can be implemented in a set of instructions stored on a computer-readable memory and executable at one or more processors of a client device 12. In other implementations, the method 500 can be executed at one or more processors of a server device 60.

At block 502, the client device 12 determines the user's current/starting location and destination location. For example, the client device 12 may determine the user's starting location by communicating with an electronic tag (e.g., a payment device, a “You are here” panel in a shopping mall, etc.) at a known location (e.g., a retail store) via a very short-range communication link. In other implementations, the user may enter user input via user controls to provide the user's starting location.

The client device 12 may determine the user's destination location by receiving user input via user controls indicating the user's destination location. In other implementations, the client device 12 determines the user's destination location when the user arrives at the destination location by communicating with an electronic tag at a known location at the destination via a very short-range communication link.

At block 504, the client device 12 determines a set of candidate paths from the starting location to the destination location. To identify the candidate paths, the client device 12 may obtain the floor plan of an area surrounding the user from the server device 60. The client device 12 may also obtain a set of unobstructed route segments within the floor plan from the server device 60 or may identify the set of unobstructed route segments by analyzing the floor plan and identifying segments which are not obstructed by a wall, door, or other obstruction. Then the client device 12 may identify a path from the starting location to the destination location using a set of connecting unobstructed route segments from the starting location to the destination location. The client device 12 may repeat this process of identifying different sets of connecting unobstructed route segments from the starting location to the destination location to identify each candidate path.

In other implementations, the client device 12 may transmit a request to the server device 60 for each of the candidate paths from the starting location to the destination location 60. The server device 60 may then analyze the floor plan and/or unobstructed route segments to generate the set of candidate paths. Then the server device 60 provides the set of candidate paths to the client device 12.

At block 506, the client device 12 estimates the locations/waypoints of the user as the user travels to the destination location. For example, the client device 12 continuously or periodically estimates the user's location/waypoint by obtaining updated GPS signals from the GPS sensor 46. Then at block 508, the client device compares the estimated locations/waypoints to waypoints on each of the candidate paths to identify the path the user is most likely traveling on to arrive at the destination location.

For example, for each candidate path, the client device 12 may determine the Euclidean distance between a location estimate and the nearest waypoint on the candidate path to the location estimate. The client device 12 may repeat this process for each location estimate and may aggregate or average the Euclidean distances for each of the location estimates to determine an aggregate or average Euclidean distance for the candidate path. Then the client device 12 may identify the candidate path with the smallest aggregate or average Euclidean distance as the most likely path.

In other implementations, the client device 12 may determine the distance in a particular direction between a location estimate and the nearest waypoint in that particular direction. The client device 12 may repeat this process for each location estimate and may aggregate or average the distances in the particular direction for each of the location estimates to determine an aggregate or average distance in the particular direction for the candidate path. Then the client device 12 may identify the candidate path with the smallest aggregate or average distance in the particular direction as the most likely path.

In some implementations, the client device 12 may assign similarity scores or metrics to each of the candidate paths based on an amount of similarity between the candidate path and the location estimates. For example, the similarity score or metric may be inversely related to the aggregate or average distance. Then the client device 12 may rank the candidate paths according to the similarity scores or metrics, and identify the candidate path ranked the highest/having the highest similarity score or metric as the most likely path.

Upon identifying the most likely path of the user to the destination location, the client device 12 adjusts the location estimates according to the identified path to determine precise waypoints/locations for the user (block 510). The client device 12 may adjust the location estimates to the nearest waypoints on the identified path. The nearest waypoint to a location estimate may be determined as the waypoint having the shortest Euclidean distance to the location estimate, the shortest distance in a particular direction to the location estimate (e.g., the direction perpendicular to the direction of the path at the particular waypoint), or in any other suitable manner. Then the client device 12 stores the location estimates with their corresponding precise waypoints/locations as correction values.

In some implementations, the client device 12 may then determine precise locations for the user using the location estimates and the stored correction values. Also in some implementations, the client device 12 may provide the precise locations to the server device 60, for example if the user selects an option to share location data. The server device 60 may then provide information to the client device 12 based on the precise location of the user (e.g., a targeted advertisement).

### Additional Considerations

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain embodiments are described herein as including logic or a number of components, modules, or mechanisms. Modules may constitute either software modules (e.g., code stored on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. As used herein “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The method 500 may include one or more function blocks, modules, individual functions or routines in the form of tangible computer-executable instructions that are stored in a non-transitory computer-readable storage medium and executed using a processor of a computing device (e.g., a network server, a personal computer, a smart phone, a tablet computer, a smart watch, a mobile computing device, or other client computing device, as described herein). The method 500 may be included as part of any backend server (e.g., a network server or any other type of server computing device, as described herein), client computing device modules of the example environment, for example, or as part of a module that is external to such an environment. Though the figures may be described with reference to the other figures for ease of explanation, the method 500 can be utilized with other objects and user interfaces. Furthermore, although the explanation above describes steps of the method 500 being performed by specific devices (such as a server device, a client device), this is done for illustration purposes only. The blocks of the method 500 may be performed by any suitable devices or other parts of the environment.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as an SaaS. For example, as indicated above, at least some of the operations may be performed by a group of computers (as examples of machines including processors), these operations being accessible via a network (e.g., the Internet) and via one or more appropriate interfaces (e.g., APIs).

Still further, the figures depict some embodiments of the example environment for purposes of illustration only. One skilled in the art will readily recognize from the following discussion that alternative embodiments of the structures and methods illustrated herein may be employed without departing from the principles described herein.

Upon reading this disclosure, those of skill in the art will appreciate still additional alternative structural and functional designs for an indoor waypoint system through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A method for determining a location of a user, the method comprising:
determining, by one or more processors, a current location of a user and a destination location;
determining, by the one or more processors, a plurality of paths for traveling from the current location to the destination location;
as the user travels to the destination location, estimating, by the one or more processors, a plurality of waypoints traversed by the user;
comparing, by the one or more processors, the estimated plurality of waypoints to each of the plurality of paths to identify a path of the plurality of paths in which the user travels to the destination location; and
adjusting, by the one or more processors, the estimated plurality of waypoints according to the identified path to determine precise waypoints for the user.

2. The method of claim 1, further comprising:
in response to identifying the path, adjusting, by the one or more processors, each subsequent estimated waypoint as the user travels to the destination location according to the identified path to determine a precise waypoint corresponding to each subsequent estimated waypoint.

3. The method of claim 1, further comprising:
for each estimated waypoint, determining, by the one or more processors, a correction value based on a difference between the estimated waypoint and a nearest waypoint on the identified path; and
in response to determining that the user is at the estimated waypoint at another point in time, applying, by the one or more processors, the correction value to the estimated waypoint to determine a precise waypoint for the user.

4. The method of claim 1, further comprising:
presenting, by the one or more processors, one or more indications of one or more of the precise waypoints for the user on an indoor map display.

5. The method of claim 1, wherein the plurality of waypoints are estimated using a positioning sensor in a client device.

6. The method of claim 1, wherein determining the current location of the user includes:
receiving, at a client device, a very short-range communication signal from an electronic tag within communication range of the client device; and
determining the current location of the user based on a known location of the electronic tag.

7. The method of claim 1, wherein identifying the path of the plurality of paths includes:
for each of the plurality of paths, determining, by the one or more processors, a similarity metric between the estimated plurality of waypoints and a set of waypoints on the path;
ranking, by the one or more processors, the plurality of paths according to respective similarity metrics for each of the plurality of paths; and
identifying, by the one or more processors, a highest ranked path of the plurality of paths.

8. A computing device for determining a location of a user, the computing device comprising:
one or more processors; and
a computer-readable memory coupled the one or more processors and storing instructions thereon that, when executed by the one or more processors, cause the computing device to:
determine a current location of a user and a destination location;
determine a plurality of paths for traveling from the current location to the destination location;
as the user travels to the destination location, estimate a plurality of waypoints traversed by the user;
compare the estimated plurality of waypoints to each of the plurality of paths to identify a path of the plurality of paths in which the user travels to the destination location; and
adjust the estimated plurality of waypoints according to the identified path to determine precise waypoints for the user.

9. The computing device of claim 8, wherein the instructions further cause the computing device to:
in response to identifying the path, adjust each subsequent estimated waypoint as the user travels to the destination location according to the identified path to determine a precise waypoint corresponding to each subsequent estimated waypoint.

10. The computing device of claim 8, wherein the instructions further cause the computing device to:
for each estimated waypoint, determine a correction value based on a difference between the estimated waypoint and a nearest waypoint on the identified path; and
in response to determining that the user is at the estimated waypoint at another point in time, apply the correction value to the estimated waypoint to determine a precise waypoint for the user.

11. The computing device of claim 8, wherein the instructions further cause the computing device to:
present one or more indications of one or more of the precise waypoints for the user on an indoor map display.

12. The computing device of claim 8, wherein the plurality of waypoints are estimated using a positioning sensor in the computing device.

13. The computing device of claim 8, wherein to determine the current location of the user, the instructions cause the computing device to:
receive a very short-range communication signal from an electronic tag within communication range of the computing device; and
determine the current location of the user based on a known location of the electronic tag.

14. The computing device of claim 8, wherein to identify the path of the plurality of paths, the instructions cause the computing device to:
for each of the plurality of paths, determine a difference metric between the estimated plurality of waypoints and a set of waypoints on the path;
rank the plurality of paths according to respective difference metrics for each of the plurality of paths; and
identify a highest ranked path of the plurality of paths.

15. A computer-readable memory coupled to one or more processors and storing instructions thereon that, when executed by the one or more processors, cause the one or more processors to:
determine a current location of a user and a destination location;
determine a plurality of paths for traveling from the current location to the destination location;
as the user travels to the destination location, estimate a plurality of waypoints traversed by the user;
compare the estimated plurality of waypoints to each of the plurality of paths to identify a path of the plurality of paths in which the user travels to the destination location; and
adjust the estimated plurality of waypoints according to the identified path to determine precise waypoints for the user.

16. The computer-readable memory of claim 15, wherein the instructions further cause the one or more processors to:
in response to identifying the path, adjust each subsequent estimated waypoint as the user travels to the destination location according to the identified path to determine a precise waypoint corresponding to each subsequent estimated waypoint.

17. The computer-readable memory of claim 15, wherein the instructions further cause the one or more processors to:
for each estimated waypoint, determine a correction value based on a difference between the estimated waypoint and a nearest waypoint on the identified path; and
in response to determining that the user is at the estimated waypoint at another point in time, apply the correction value to the estimated waypoint to determine a precise waypoint for the user.

18. The computer-readable memory of claim 15, wherein the instructions further cause the one or more processors to:
present one or more indications of one or more of the precise waypoints for the user on an indoor map display.

19. The computer-readable memory of claim 15, wherein the plurality of waypoints are estimated using a positioning sensor in a client device.

20. The computer-readable memory of claim 15, wherein to determine the current location of the user, the instructions cause the one or more processors to:
receive a very short-range communication signal from an electronic tag within communication range of a client device; and
determine the current location of the user based on a known location of the electronic tag.
